(19) United States
(12) Patent Application Publication
(10) Pub. No.: US 2024/0377022 A1
(43) Pub. Date: Nov. 14, 2024

(54) Multi-Use Clip with Attachments for Parents and Caregivers

(71) Applicant: Monarch Kid Co, San Antonio, TX (US)

(72) Inventor: Benjamin Rey Lopez, San Antonio, TX (US)

(21) Appl. No.: 18/658,660

(22) Filed: May 8, 2024

Related U.S. Application Data
(60) Provisional application No. 63/500,814, filed on May 8, 2023.

(51) Int. Cl. F16M 13/02

(52) U.S. Cl. CPC F16M 13/022

(57) ABSTRACT

The present invention is a device intended to limit the frequency and reduce the impact of children dropping toys, utensils, and other objects on the floor. The device comprises a clip that attaches to a surface or other fixed structure in close proximity to a child or other use, a strap that is removably attached to the clip, and an attachment receiver that is removably attached to the clip. The strap comprises a strap button, a strap connector, and one or more strap anchors positioned between the strap button and the strap connector.

### CROSS REFERENCES TO RELATED APPLICATION

Not applicable.

### FEDERALLY SPONSORED RESEARCH OR DEVELOPMENT

Not applicable.

### BACKGROUND OF THE INVENTION

### 1. Field of the Invention

This invention relates to the field of fastening and attachment apparatuses, especially those intended for parents and caregivers.

### 2. Description of the Related Art

Children drop items. Younger children drop items more frequently than older children. Accidentally or intentionally dropping and throwing items can lead to a parent or caregiver constantly having to pick up items, leading to frustration.

Others have tried to alleviate the problems associated with children dropping items and parents picking them up. For example, have proposed other devices incorporating silicone mating that uses suction to stick on a surface or circular suction cups.

### SUMMARY OF THE INVENTION

The present invention was developed to address the problems discussed above. The present invention is a clip that can be attached to multiple surfaces. It also includes a silicon strap and one or more attachments. The end of the strap can be looped through items such as bottles, toys, or other various items that can be looped through. The attachments can be added to the strap to hold various items such as utensils, stuffed animals, art supplies, and other various items.

The benefit of the present invention is that it prevents items from falling to the ground. For example, the clip is attached to a surface such as a table or high chair and the attachments that are connected to the strap have the ability to hold utensils and other items. If the user drops the utensil accidentally or on purpose, the device prevents the utensil from falling to the ground. The parent, caretaker, or user can simply pull the utensil back onto the table.

The apparatus of the present invention overcomes the problem described above by providing a clip that has the ability to be clamped down onto multiple surface shapes. The second component is the silicone strap, which has the ability to loop through many items as well as the attachments. The third component is the attachment(s), which has the ability to hold many utensils and other items that fit inside of the round attachments.

### BRIEF DESCRIPTION OF THE SEVERAL VIEWS OF THE DRAWINGS

For an improved understanding of the present invention, and the advantages thereof, reference is made to the following descriptions taken in conjunction with the accompanying drawings. The accompanying drawings illustrate several embodiments and, together with the description, serve to explain the principles of the invention according to the embodiments. It will be appreciated by one skilled in the art that the particular arrangements illustrated in the drawings are merely exemplary and are not to be considered as limiting of the scope of the invention or the claims herein in any way.

FIG. 1 is a perspective view of one embodiment of the invention in use with a drinking vessel, the drinking vessel shown in dashed lines because it is part of the environment.

FIG. 2 is a perspective view of one embodiment of the invention.

FIG. 3 is an exploded view of part of the embodiment of the invention illustrated in FIG. 2.

FIG. 4A is a side view of part of the embodiment of the invention illustrated in FIG. 2.

FIG. 4B is a perspective view of part of the embodiment of the invention illustrated in FIG. 2.

FIG. 5A is a side view of part of the embodiment of the invention illustrated in FIG. 2.

FIG. 5B is a perspective view of part of the embodiment of the invention illustrated in FIG. 2.

FIG. 6A is a side view of part of the embodiment of the invention illustrated in FIG. 2.

FIG. 6B is a perspective view of part of the embodiment of the invention illustrated in FIG. 2.

FIG. 7 is a perspective view of part of the embodiment of the invention illustrated in FIG. 2.

FIG. 8A is a top view of part of the embodiment of the invention illustrated in FIG. 2.

FIG. 8B is a side view of part of the embodiment of the invention illustrated in FIG. 2 and FIG. 8A.

FIG. 9A is a perspective view of part of the embodiment of the invention illustrated in FIG. 2.

FIG. 9B is a cross-sectional view of part of the embodiment of the invention illustrated in FIG. 2 and FIG. 9A.

FIG. 10 is a perspective view of one embodiment of the invention in use with a fork, the fork shown in dashed lines because it is part of the environment, and the embodiment of the invention is secured to a high-chair.

FIG. 11A and FIG. 11B are two views of an alternative embodiment of the present invention.

FIG. 12 is one view of an alternative embodiment of the strap component of the invention.

FIG. 13 is one view of an alternative embodiment of the clip of the component of the invention.

### DETAILED DESCRIPTION OF THE INVENTION

### 1. General Considerations

The present invention disclosure is for a clip assembly. The invention is described by reference to various elements herein. It should be noted, however, that although the various elements of the inventive apparatus are described separately below, the elements need not necessarily be separate. The various embodiments may be interconnected and may be cut out of a singular block or mold. The variety of different ways of forming an inventive apparatus, in accordance with the disclosure herein, may be varied without departing from the scope of the invention.

Generally, one or more different embodiments may be described in the present application. Further, for one or more of the embodiments described herein, numerous alternative arrangements may be described; it should be appreciated that these are presented for illustrative purposes only and are not limiting of the embodiments contained herein or the claims presented herein in any way. One or more of the arrangements may be widely applicable to numerous embodiments, as may be readily apparent from the disclosure. In general, arrangements are described in sufficient detail to enable those skilled in the art to practice one or more of the embodiments, and it should be appreciated that other arrangements may be utilized and that structural changes may be made without departing from the scope of the embodiments. Particular features of one or more of the embodiments described herein may be described with reference to one or more particular embodiments or figures that form a part of the present disclosure, and in which are shown, by way of illustration, specific arrangements of one or more of the aspects. It should be appreciated, however, that such features are not limited to usage in the one or more particular embodiments or figures with reference to which they are described. The present disclosure is neither a literal description of all arrangements of one or more of the embodiments nor a listing of features of one or more of the embodiments that must be present in all arrangements.

Headings of sections provided in this patent application and the title of this patent application are for convenience only and are not to be taken as limiting the disclosure in any way.

Devices and parts that are connected to each other need not be in continuous connection with each other, unless expressly specified otherwise. In addition, devices and parts that are connected with each other may be connected directly or indirectly through one or more connection means or intermediaries.

A description of an aspect with several components in connection with each other does not imply that all such components are required. To the contrary, a variety of optional components may be described to illustrate a wide variety of possible embodiments and in order to more fully illustrate one or more embodiments. Similarly, although process steps, method steps, or the like may be described in a sequential order, such processes and methods may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the embodiments, and does not imply that the illustrated process is preferred. Also, steps are generally described once per aspect, but this does not mean they must occur once, or that they may only occur once each time a process, or method is carried out or executed. Some steps may be omitted in some embodiments or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or features of a device may be alternatively embodied by one or more other devices that are not explicitly described as having such functionality or features. Thus, other embodiments need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Alternate implementations are included within the scope of various embodiments in which, for example, functions may be executed out of order from that shown or discussed, including substantially concurrently or in reverse order, depending on the functionality involved, as would be understood by those having ordinary skill in the art.

### 2. Considerations Specific to the Invention

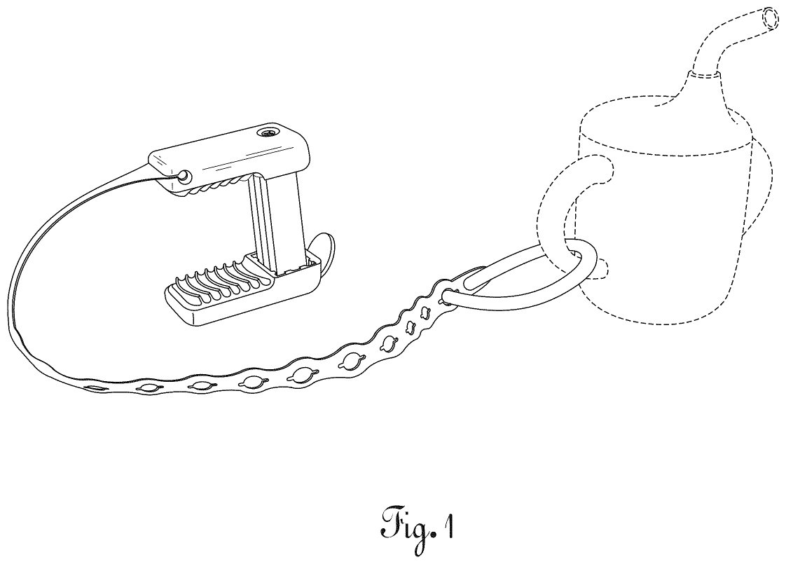

FIG. 1 is a perspective view of one embodiment of the invention in use with a drinking vessel. The drinking vessel is shown in dashed lines because it is part of the environment.

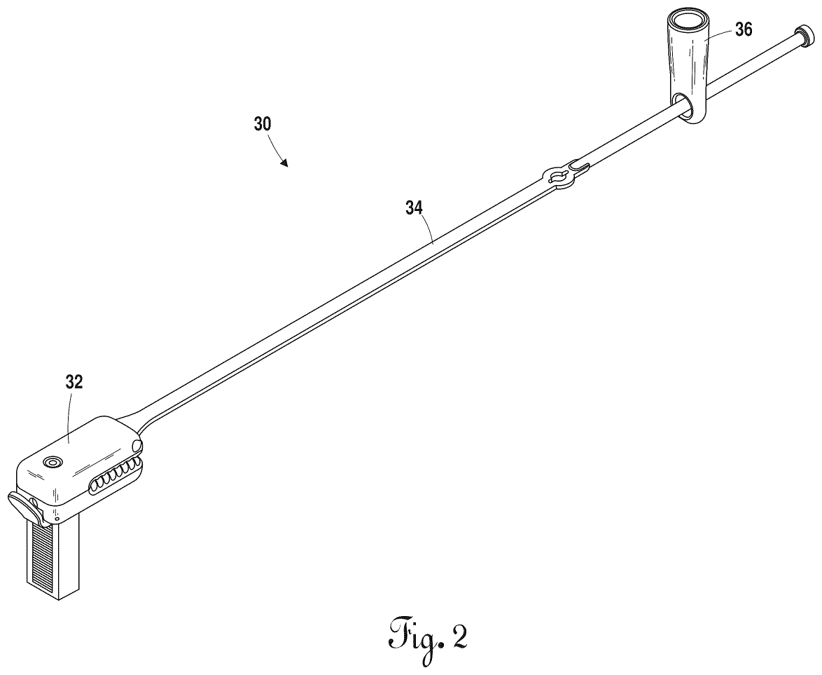

FIG. 2 is a perspective view of one embodiment of the invention. The device 30 comprises a clip 32, a strap 34, and an attachment receiver 36. Each of these components is illustrated and discussed in greater detail below.

FIG. 3 illustrates clip 32. Clip 32 comprises a top clip jaw 38, a bottom clip jaw 40, a clip stem 42, a clip tab 44, and hardware. The hardware shown here includes a threaded screw 46 and a pin 48. When the device 30 is in use, a user can secure the clip around a surface (e.g., table, high chair, stroller, etc.). In this embodiment, the screw 46 secures the top clip jaw 38 to the clip stem 42. The screw 46 does not connect to the bottom clip jaw 40. However, the bottom clip jaw 40 is adjustable relative to the top clip jaw 38 along the clip stem 42. When the screw 46 is in place, the bottom clip jaw remains in contact with the clip stem 42. As a result, the user can loosen and tighten the clip 32 by adjusting the bottom clip jaw 38 along the clip stem 42. Each of these components is illustrated and discussed in greater detail below.

FIG. 4A and FIG. 4B illustrate two views of the top clip jaw 38 in this embodiment of the invention. The top clip jaw 40 comprises atop clip jaw body 50, a top clip jaw lower body 52, a top rubber grip 54, a strap connector receiver 56, a strap gap 58, and a stem recess 60. The device 30 shown in these figures was designed to be lightweight and ergonomic. It is also designed with aesthetics in mind. The top clip jaw lower body 52 adds thickness to the top clip jaw 38 in order to properly receive and secure the clip stem 42. The perimeter and shape of the recess 60 generally correspond to the shape of the clip stem 42. Such correspondence allows for a secure fit between the top clip jaw 38 and the clip stem 42. It is further enhanced in this device by adding multiple concave and concave portions of the receive complementary of the clip stem 42. The complementary shape between the clip stem 42 and the bottom clip jaw 40 improves smooth movement between the two pieces. In allows the pieces to move in a straight path relative to one another.

The top rubber grip 54 exists along a face of the top clip jaw 38. In this embodiment, the top rubber grip 54 exists on a face opposite of the hole in the top clip jaw 38 that receives the threaded screw 46. The top rubber grip 54 will come into contact with surfaces (e.g., tables, chairs, strollers). It provides friction and facilitates an effective attachment of the device to the larger object. The strap connector receiver 56 and the strap gap 58 are intended to collectively receive and secure the strap 34 to the clip 32. Specifically, the parent/caregiver can slide the strap connector 62 of the strap 34 through the strap connector receiver 56, which is slightly larger, but of complementary size, than the strap connector 62. In this embodiment, the strap connector 62 and the strap connector receiver 56 are both generally circular in shape. The interstitial space forming the strap gap 58 is narrower than the diameter of the strap connector receiver 56. That relationship allows strap 34 to remain in place relative to clip 32 even when the user pulls on device 30 or other forces are applied. The strap 34 can be removed from clip 32, but someone needs to slide the strap connector 62 through the strap connector receiver 56, which requires more effort and coordination than merely pulling on the strap or its attachments.

FIG. 5A and FIG. 5B illustrate two views of the bottom clip jaw 40 in this embodiment of the invention. The bottom clip jaw 40 comprises a bottom clip jaw body 63, a bottom clip jaw upper body 64, a bottom rubber grip 66, pinholes 68, a stem orifice 70, and a tab recess 72.

The bottom clip jaw upper body 64 adds thickness to the bottom clip jaw 40 in order to properly receive and secure the clip stem 42. The perimeter and shape of the stem orifice 70 generally correspond to the shape of the clip stem 42. Such correspondence allows for a secure fit between the bottom clip jaw 40 and the clip stem 42. It is further enhanced in this device by adding multiple concave and concave portions of the receive complementary of the clip stem 42. The complementary shape between the clip stem 42 and the bottom clip jaw 40 improves smooth movement between the two pieces. In allows the pieces to move in a straight path relative to one another.

The bottom rubber grip 66 exists along a face of the bottom clip jaw 40. The bottom rubber grip 66 will come into contact with surfaces (e.g., tables, chairs, strollers). It provides friction and facilitates an effective attachment of the device to the larger object. Pinholes 68 are intended to receive pin 48 and secure the clip tab 44 to the bottom clip jaw 40. The pin also allows slight rotation movement of the clip tab 44, which as discussed below allows the parent/caregiver to adjust the bottom clip jaw 40 relative to the clip stem 42.

When the clip tab 44 is connected to the bottom clip jaw 40 by way of the pin 48, the user can bring the clip tab 44 closer to the bottom clip jaw 40 and hold it in that position by securing the clip tab knub 74 to the tab recess 72.

FIG. 6A and FIG. 6B illustrate two views of the clip stem 42 in this embodiment of the invention. The clip stem 42 comprises a clip stem body 75, a threaded hole 76, a plurality of clip stem teeth 78, a stem foot 80, and stem grooves 82a, 82b, 82c.

The threaded hole 76 is positioned on one face of the clip stem 42 and receives threaded screw 46 when securing the top clip jaw 38 to the clip stem 42. The plurality of teeth 78 exist alongside a face of the clip stem. The teeth are angled indentions in the clip stem 42 that allow the user to secure the bottom clip jaw 40 in place relative to the clip stem 42. In this embodiment, the bottom clip jaw 40 ratchets along the teeth 78.

In this embodiment, the clip stem 42 comprises a stem foot 80, which protrudes from a face of the clip stem 42 opposite the face comprising the threaded hole 76. The stem foot 80 prevents the bottom clip jaw 40 from sliding off of the clip stem 42. As a result of the threaded hole 76 and the stem foot 80 existing at opposite ends of the clip stem 42, the parent/caregiver can adjust the bottom clip jaw 40 along almost the entire length of the clip stem 42 (minus the thickness of the top clip jaw 38, which is fixed in place).

As discussed above, the profile of the jaws 38, 40 complement the profile of the clip stem 42 to improve stability, as well as movement/use of the device 30. FIG. 6B illustrates several grooves 82a, 82b, 82c, which match with convex/protruding portions of jaw 40.

FIG. 7 illustrates two views of the clip tab 44 in this embodiment of the invention. The clip tab 44 comprises a clip tab knub 74, tab pinholes 84, tab legs 86, a wedge 88, and tab 90. The clip tab 44 attaches to the bottom clip jaw 40 by way of the pin 48 at tab pinholes 84, which exist in the tab legs 86. Because of this relationship, the clip tab 44 can rotate relative to the bottom clip jaw 40. The user can prompt the pivot by pushing or pulling on tab 90. When the clip tab 44 rotates relative to the bottom clip jaw 40, the wedge 88 can move toward or away from the clip stem 42, namely, the clip stem teeth 78. When the tab 90 is not pushed or pulled, the wedge 88 remains fixed relative to the teeth 78 and the bottom clip jaw 40 remains in place relative to the clip stem 42. When the tab 90 is pushed/pulled, the wedge moves away from the teeth 78 and the user can move the bottom clip jaw 40 relative to the clip stem 42.

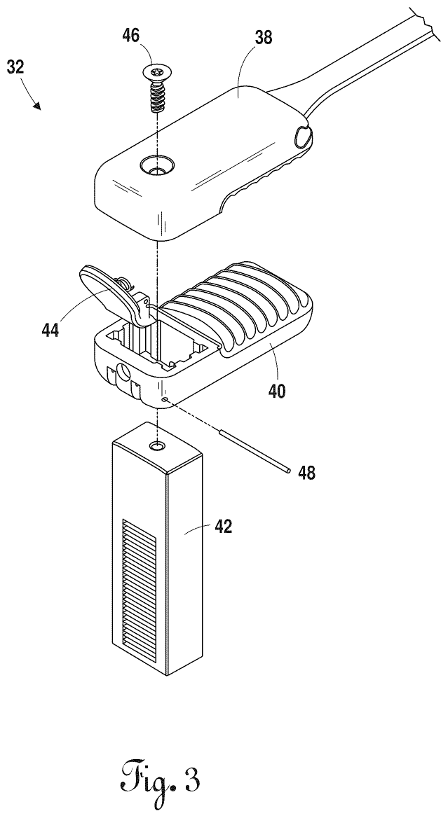

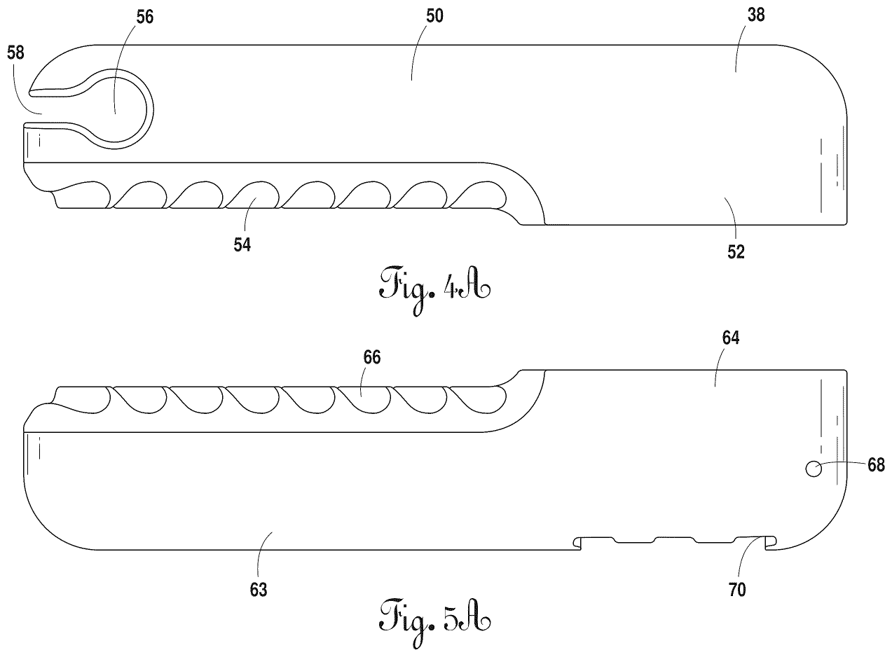

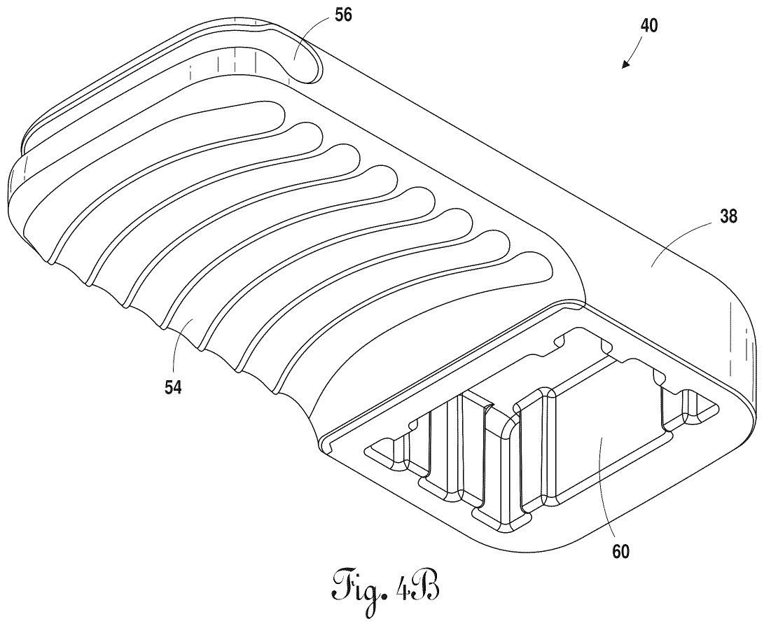

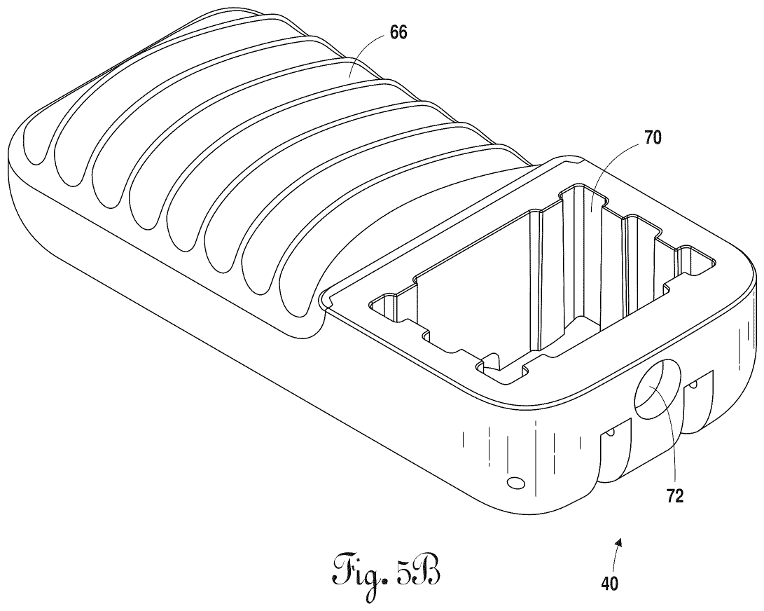

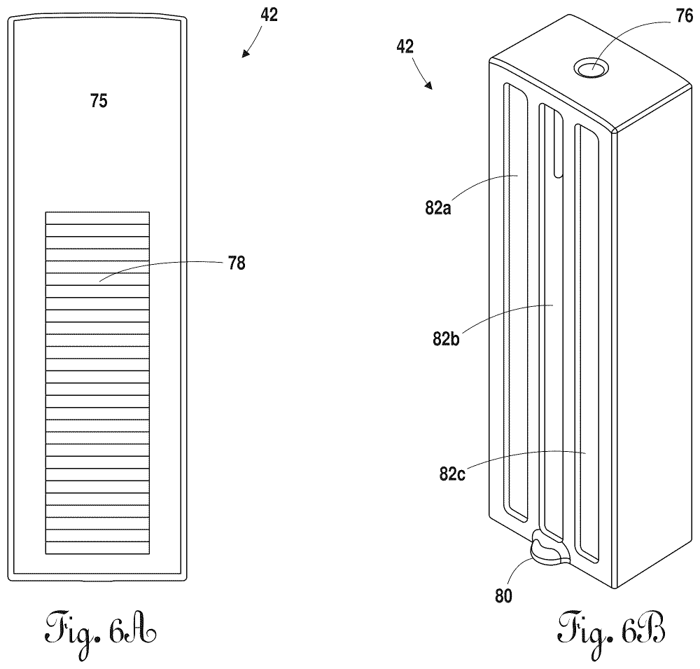

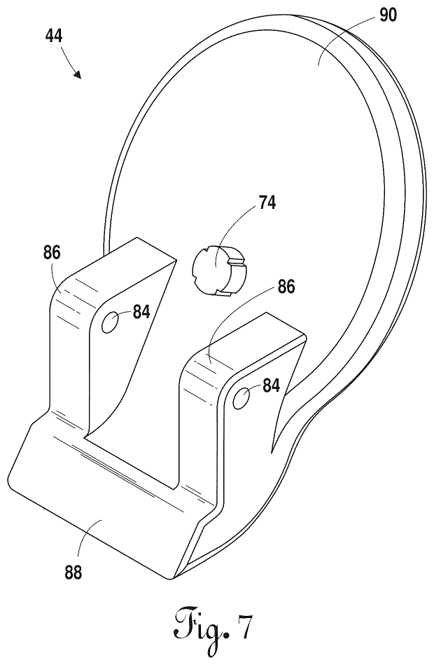

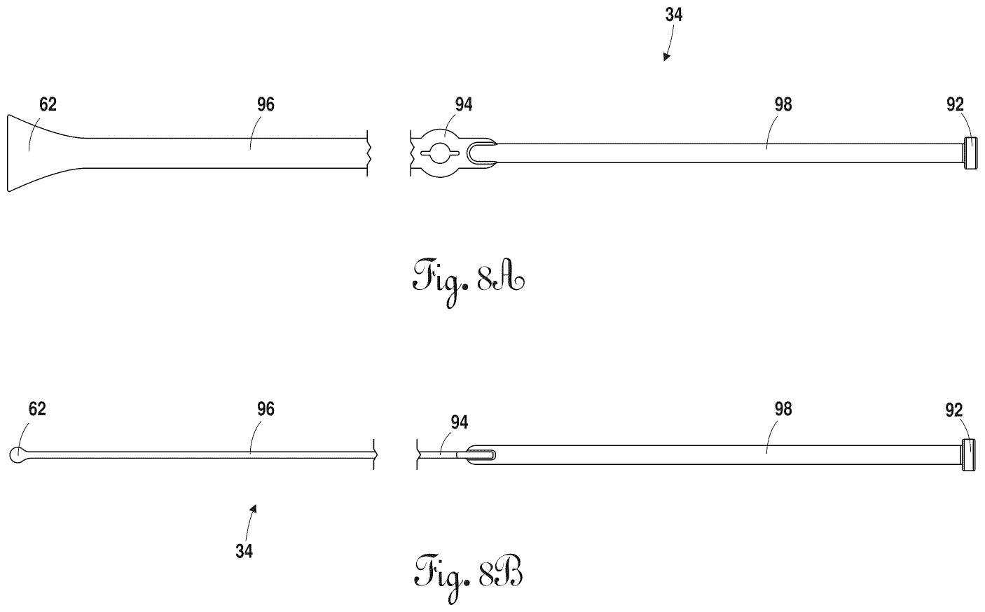

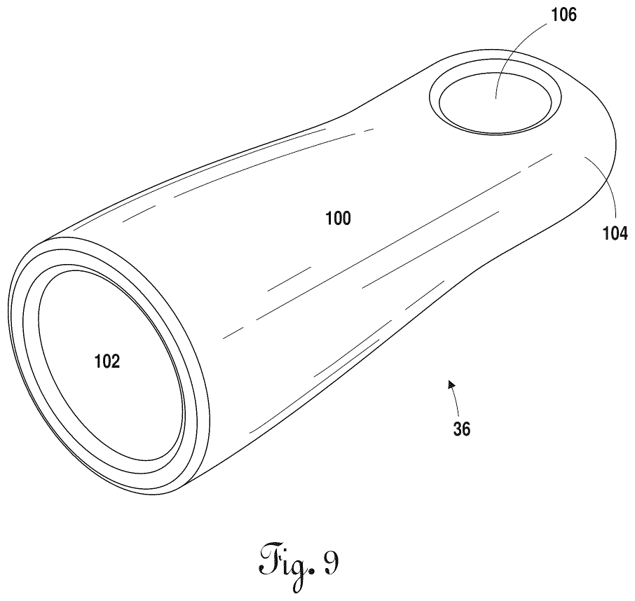

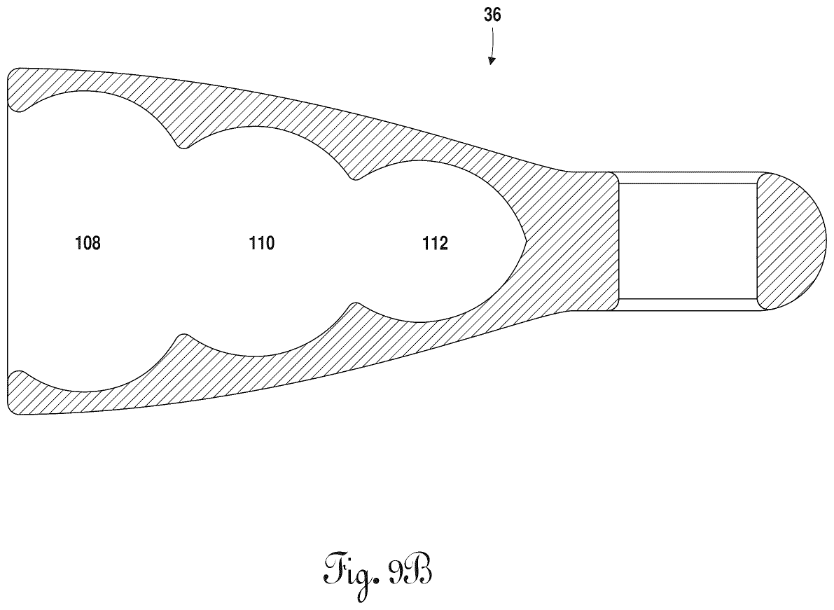

FIG. 8A and FIG. 8B illustrate two views of the strap 34 in this embodiment of the invention. The strap 34 comprises a strap connecter 62 and a strap button 92 located at opposing ends of the strap 34, a strap anchor 94, a flat segment 96 existing along the strap between the strap connector 62 and the strap anchor 94, and a round segment 98 existing along the strap button 92 and the strap anchor 94.

As discussed above, the strap connector 62 is of appropriate shape (e.g., circle/cylinder) to slide and rest within the strap connector receiver 56. Strap button is generally a cylinder/circular shape having a diameter. Strap button serves two primary functions. First, it helps prevent attachment receiver 36 (and similar objects) from sliding off of the strap 34. That is, the diameter of the strap button is wider than the relevant hole along the attachment receiver 36. Second, the strap button 92 can pass through the orifice existing within strap anchor 94, as desired by the user. In this embodiment, the orifice existing within the strap anchor 94 is a circle having a diameter that is slightly less than the diameter of the strap button 92. This relationship prevents the strap button from sliding out of the strap anchor 94, which would eliminate the closed loop formed by the round segment 98 when the strap button has been passed through the strap anchor. In this embodiment, the orifice existing within the strap anchor has slits, which allow the strap button to pass through strap anchor orifice when desired by the user. The loop formed by the round segment allows the user to secure objects like sippy cups having handles and other objects to the device. Compare FIG. 1 with FIG. 2.

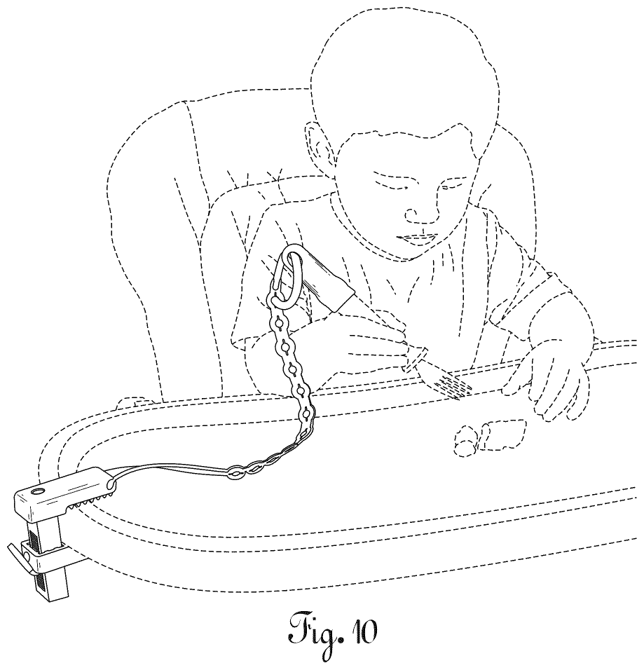

FIG. 9A and FIG. 9B illustrate two views of the attachment receiver 36 in this embodiment of the invention. The attachment receiver 36 comprises a chamber body 100, a chamber 102, a loop body 104, and a loop 106. The chamber 102 further comprises internal chambers 108, 110, 112.

The attachment receiver 36 is made of a compressible, flexible, and/or adjustable material that allows for a user to place a utensil, crayon, or other object inside of the chamber 102 in order for a child to use the utensil, crayon, or other object while the child holds the chamber body 100. The chamber comprises internal chambers of increasing/decreasing diameter to accommodate utensils, crayons, or other objects of varying sizes. The combination of the material of the receiver 36 and the internal chamber sizes promotes a good fit on the utensil, crayon, or other object. The loop body 104 extends from the chamber body 100. A loop 106 exists as an orifice within the loop body 104. In some embodiments, the loop 106 is of appropriate size and shape for the user to intentionally pass the strap button through the loop 106 with effort and otherwise leave the attachment receiver 36 in place relative to the rest of the remainder device. Additionally, and in many embodiments, the user may form a loop with the round segment 98 after passing the strap button 92 through loop 106 and then through the strap anchor orifice.

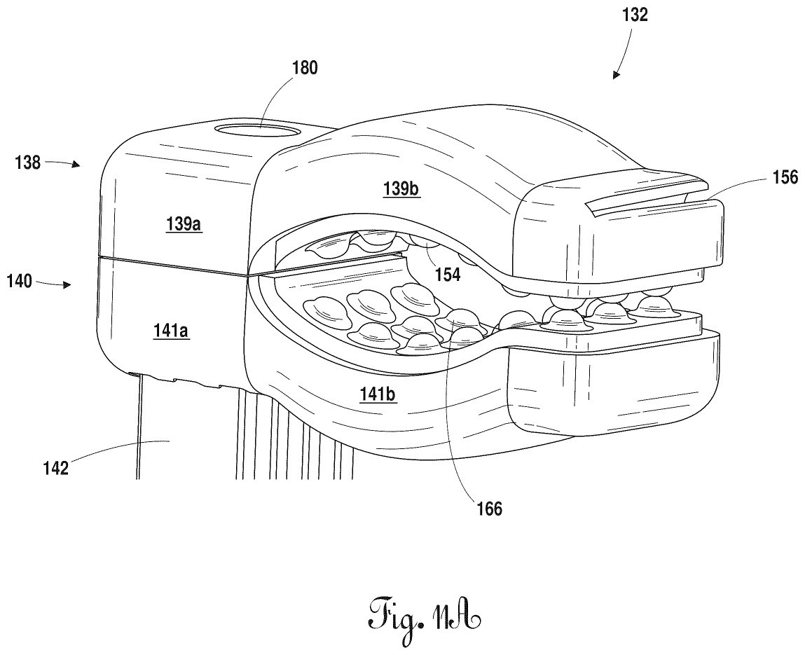

FIG. 10 illustrates an embodiment of the device wherein the clip 32 is secured to a tray and a fork is secured to the device by virtue of the closed loop formed in the round segment 98 through the strap anchor 94 of the strap 34.

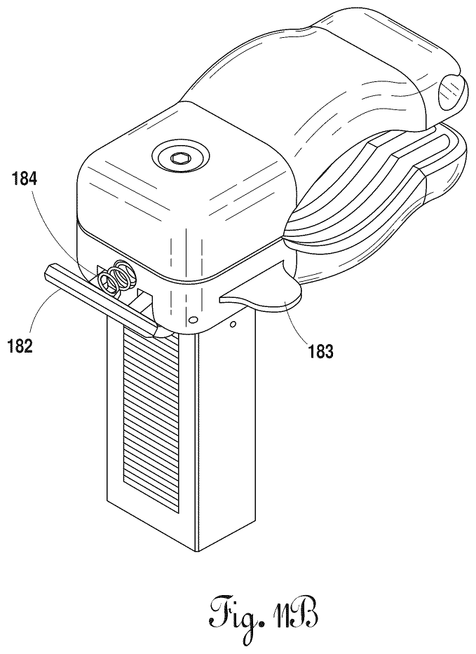

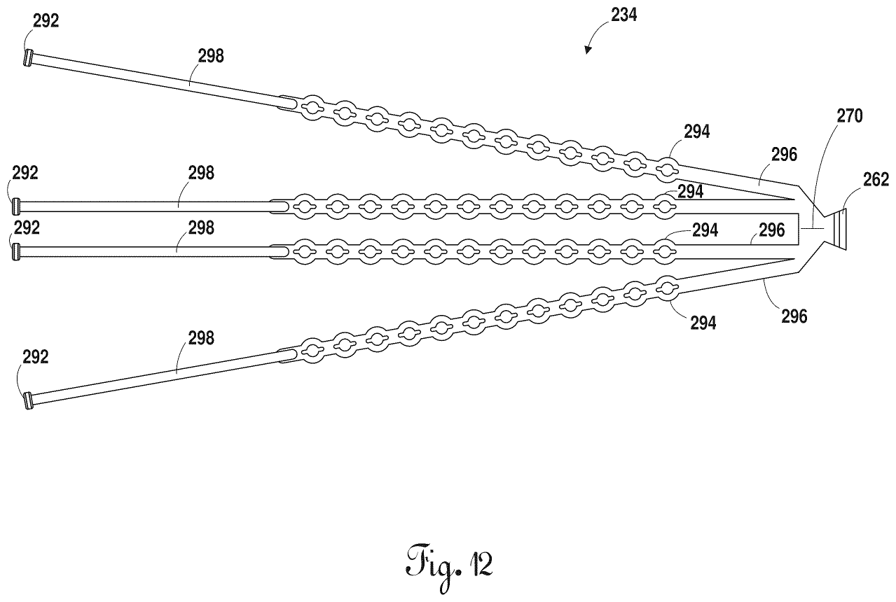

FIG. 11A illustrates an alternative embodiment of the present invention. One of the primary differences of the embodiment shown in FIG. 11A versus the embodiment shown in FIG. 1 through FIG. 7 is that the jaw components and grips are not flat and entirely parallel to one another. The clip 132 shown in this embodiment consists of a top clip jaw 138, a bottom clip jaw 140, and a clip stem 142. The top clip jaw 138 comprises a top clip stem section 139a, top clip grip section 139b, and a top rub grip 154 adorning one of the faces of the top clip grip section 139b. Like the embodiment described above, the top clip jaw 138 a strap connector receiver 156. The strap connector receiver 156 exists near one edge of the top clip section 139b. Unlike the earlier embodiment, the strap connector receiver 156 does not span an entire width of the top clip jaw (i.e., from one face to the other face). In the earlier embodiment, a strap connector 62 can slide in or out of two different sides of the top clip jaw/strap connector receiver. In this embodiment, the strap connector slides in and out of one opening to the strap connector receiver 156, reducing the likelihood/opportunity for the strap connector to separate from the clip 132. A top clip threaded hold 180 exists on one face of the top clip jaw 138. A threaded screw can pass through the threaded hole 180 and secure the top clip jaw 138 with the clip stem 142.

The bottom clip jaw 140 comprises a bottom clip stem section 141a, bottom clip grip section 141b, and a bottom rub grip 166 adorning one of the faces of the top clip grip section 141b.

The top clip grip section 139b and bottom clip grip section 141 each have portions that are rounded and portions that are relatively flat. The rounded portion may provide greater stability between the clip 132 and a surface when the surface is rounded (e.g., the handle bar of a stroller; the frame of a child play pin). The flat portion may provide greater stability between the clip 132 and a surface when the surface is flat (e.g., a desk; high chair). The round silicone bumps improve compression when clamped down. Consequently, in some embodiments the circular bumps have a better effect on securing the clip to tables, chairs and other surfaces.

FIG. 11B illustrates another alternative embodiment of the present invention. In this embodiment, a spring 184 exists between clip tab 182 and the bottom clip jaw. This embodiment further comprises side tab 183. Side tab 183 can be used in conjunction with or alternatively to clip tab 182 to adjust the position of the bottom clip jaw along the clip stem relative to the top clip jaw.

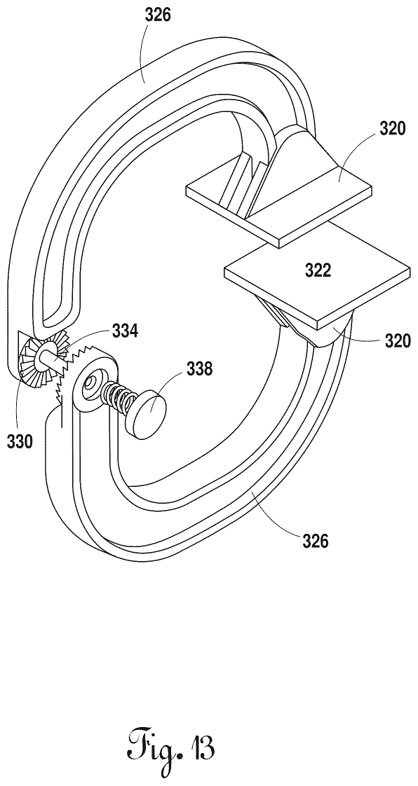

FIG. 12 illustrates an alternative embodiment of strap 234. This embodiment shows that strap 234 comprises a plurality of strap pieces extending from the strap connector 262. Specifically, shoulder 270 exists between the strap connector 262 and the four strap pieces. The shoulder extends the width and spacing available for the strap pieces to extend in different directions. In this embodiment, the two interior strap pieces exist in parallel with one another. The two exterior strap pieces exist at an angle with one another and the other strap pieces.

Each strap piece comprises a strap button 292, along with a plurality of strap anchors 294 existing between shoulder 270 and the relevant strap button 292. Each strap piece comprise It is not necessary that the strap pieces exist in the arrangement shown in FIG. 12. There could be more or fewer strap pieces; more or fewer strap anchors. The strap pieces could exist at different angles a flat portion 296 and a rounded portion 298.

An embodiment with multiple strap pieces allows the user to more easily tether multiple objects to the device. For example, a parent might want to secure a crayon, a sippy cup, and a stuffed animal to the device. This embodiment might not be attractive to a parent who wants their child(ren) to focus on one object at a time. This embodiment shows, how a user can secure multiple objects with a single clip.

FIG. 13 illustrates a further alternative embodiment of the invention. In this embodiment, the device comprises two clamp elbows 336. Each of the elbows 336 comprises a ratcheting wheel 330 at a distal end of that elbow 336. The wheels 330 are separated by a pin 334 that rotates by way of a screw 338. The screw adjusts the elbows relative to another, and accordingly the clamp interfaces 320 (discussed below).

Positioned at a proximal end of each elbow 336 is a clamp interface 320. Each clamp interface has an interior face 322 that faces the opposite clamp interface. A user may wish to secure an object with the device. The device can tighten or loosen by turning the screw 338.

In some alternative embodiments, the device might comprise features in addition to or alternative to the attachment receiver. For example, some embodiments will incorporate a belt assembly, a loop and cinch assembly, or a rubber band assembly.

In alternative embodiments, the strap connector 62 and the strap connector receiver 56 could be a different shape than a circle, with other complementary shapes existing.

In alternative embodiments, the range could be reduced or modified by positioning the stem foot or the threaded hole at different positions along the clip stem. In further alternative embodiments, the teeth could be located in fewer locations or in sections.

In alternative embodiments, the strap 34 might comprise a plurality of strap anchors.

In alternative, embodiments, the strap button and the strap anchor orifice might be a shape other than a circle.

In some alternative embodiments, a belt assembly (e.g., peg and loop) along the clip rather than a strap connector receiver. For example, some embodiments will incorporate a belt assembly, a loop and cinch assembly, or a rubber band assembly.

In some alternative embodiments, the clip jaws may be tightened or loosened relative to one another by way of a rotational piece and threaded/screw assembly-rather than or in addition to a tooth, wedge assembly.

In some alternative embodiments, the clip jaws may be tightened or loosened at one of each of their ends and rotate relative to one another along a pin assembly. In some of these embodiments, the clip jaws will have magnets that attract the clip jaws to one another.

In some alternative embodiments, one of the clip jaws will comprise a tab that pivots and opens and closes depending on whether the user wants to tighten/loosen the clip versus lock it in place.

In some alternative embodiments, one of the clip jaws will comprise a loop and/or snap/button attachment that the strap passes through and secures to.

The present invention is described above in terms of a preferred illustrative embodiment in which a specifically described multi-use clip assemblies are described. Those skilled in the art will recognize that alternative constructions of such an apparatus, system, and method can be used in carrying out the present invention. Other aspects, features, and advantages of the present invention may be obtained from a study of this disclosure and the drawings, along with the appended claims.

### 3. Additional Considerations

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for creating a secure attachment through the disclosed principles herein. Thus, while particular embodiments and applications have been illustrated and described, it is to be understood that the disclosed embodiments are not limited to the precise construction and components disclosed herein. Various apparent modifications, changes and variations may be made in the arrangement, operation and details of the method and apparatus disclosed herein without departing from the spirit and scope defined in the appended claims.

We claim:

1. A clip assembly comprising:
a clip;
a strap that is slidably and removably attached to the clip; and
an attachment receiver that is removably attached to the strap.

2. The clip assembly of claim 1 wherein the clip comprises a clip stem, a top clip jaw attached to the clip stem, and a bottom clip jaw slidably attached to the clip stem.

3. The clip assembly of claim 2 wherein:
the top clip jaw comprises a strap connector receiver having a diameter and a strap gap narrower than the diameter of the strap connector receiver;
the strap comprises a strap connector having a diameter, and the diameter of the strap connector is shorter than the diameter of the strap connector receiver.

4. The clip assembly of claim 2 wherein:
the bottom clip jaw further comprises a wedge and a tab;
the clip stem has a plurality of teeth.

5. The clip assembly of claim 1 wherein the strap comprises a strap button and a strap anchor, a round segment existing along the strap between the strap button and the strap anchor, the round segment having a first diameter, the strap button having a second diameter, the strap anchor having a third diameter, wherein the second diameter is longer than the first diameter and the second diameter.

6. The clip assembly of claim 1 wherein:
the attachment receiver comprises a chamber body and a loop body;
a plurality of internal chambers exist within the chamber body, at least one of said plurality of internal chambers narrower than another of at least one of said plurality of internal chambers; and
the loop body comprising an orifice.

7. The clip assembly of claim 1 wherein the strap comprises a single strap connector and a plurality of strap buttons extending away from the single strap connector along a corresponding number of strap segments, each of said strap segments comprising at least one strap anchor.

8. A clip assembly comprising:
a top clip jaw having a top rubber grip, a strap gap, a strap connector receiver;
a bottom clip jaw having a bottom rubber grip; and
a clip stem slidably connected to the bottom clip jaw.

9. The clip assembly of claim 8 comprising a clip tab.

10. A clip assembly comprising:
a top clip jaw;
a bottom clip jaw;
a clip stem; and
a strap that is slidably and removably attached to the clip.
